(19) United States
(12) Patent Application Publication
(10) Pub. No.: US 2006/0239747 A1
(43) Pub. Date: Oct. 26, 2006

(54) Method and apparatus for controlling temperature of image forming apparatus

(75) Inventor: Suk-gyun Han, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/408,017

(22) Filed: Apr. 21, 2006

(30) Foreign Application Priority Data
Apr. 22, 2005 (KR) 2005-33545

(51) Int. Cl. B41J 13/00

(52) U.S. Cl. 400/578

(57) ABSTRACT

An apparatus for controlling temperature of an image forming apparatus includes: a temperature sensing unit including a plurality of temperature sensors to sense temperatures of respective parts of the image forming apparatus; a paper feeding time converting unit converting the sensed temperatures into printing paper feeding times according to a fuzzy rule for converting temperatures into paper feeding times; and a paper feeding unit feeding the printing paper in accordance with the converted paper feeding times. The inner temperature of the image forming apparatus is sensed by a plurality of temperature sensors so that the entire temperature of the image forming apparatus can be controlled. A paper feeding time is adjusted so that the temperature of the image forming apparatus can be effectively controlled without additional mechanical design.

### CROSS-REFERENCE TO RELATED APPLICATION

This application claims the benefit of Korean Patent Application No. 2005-33545, filed on Apr. 22, 2005, in the Korean Intellectual Property Office, the disclosure of which is incorporated herein in by reference.

### BACKGROUND OF THE INVENTION

1. Field of the Invention

Aspects of the present invention relate to an image forming apparatus such as a printer, a facsimile, and a multi-function peripheral (MFP), and more particularly, to a method and apparatus for controlling the temperature of an image forming apparatus by performing fuzzy inference on temperatures sensed by a plurality of temperature sensors and adjusting a paper feeding time.

2. Description of the Related Art

In a conventional method of controlling the temperature of an image forming apparatus during an output process that generates heat, the image forming apparatus has been mechanically designed so that the heat can be easily dissipated. Alternatively an apparatus, such as a fan, for lowering the temperature of the image forming apparatus has been mounted mechanically on the image forming apparatus to dissipate the heat.

However, the ability to control the temperature of an image forming apparatus using the conventional temperature control method is limited. If reliance is placed on mechanical design to control the temperature, the entire size of the image forming apparatus increases, a large amount of electric power is consumed during the long-term operation of the image forming apparatus, mechanical parts are worn and noise occurs.

### SUMMARY OF THE INVENTION

Aspects of present invention provide a method and an apparatus for controlling temperature of an image forming apparatus by performing fuzzy inference on the temperature sensed by a plurality of temperature sensors and adjusting a paper feeding time.

According to an aspect of the present invention, there is provided an apparatus for controlling the temperature of an image forming apparatus by adjusting the paper feeding time. The apparatus includes: a temperature sensing unit including a plurality of temperature sensors to sense temperatures of respective parts of the image forming apparatus; a paper feeding time converting unit that converts the sensed temperatures into a paper feeding time according to a fuzzy rule for converting temperatures into paper feeding times; and a paper feeding unit that feeds the printing paper in accordance with the converted paper feeding time.

According to an aspect of the present invention, the temperature sensing unit may include the temperature sensors in parts of the image forming apparatus that dissipate heat and/or in parts of the image forming apparatus that are sensitive to heat.

According to an aspect of the present invention, the paper feeding time converting unit may apply different fuzzy rules with respect to sensed temperatures of different temperature sensors in accordance with where in the image forming apparatus the temperature sensors are disposed.

According to an aspect of the present invention, the paper feeding time converting unit may include: a fuzzy data converting portion that converts the sensed temperatures into fuzzy data; and a paper feeding time calculating portion that converts the converted fuzzy data into a paper feeding time.

According to an aspect of the present invention, the fuzzy data converting portion may include: a temperature data converting portion that converts the sensed temperatures into temperature data that represents correlations with predetermined ranges of temperatures; and a time data converting portion that converts the converted temperature data into paper feeding time data that represents predetermined ranges of paper feeding times.

According to an aspect of the present invention, the time data converting portion may include: a fuzzy inference portion that infers the ranges of the paper feeding times corresponding to the ranges of temperatures having correlations with the sensed temperatures according to the fuzzy rule; and a correlation adjusting portion that adjusts correlations of the inferred ranges of the paper feeding times using the temperature data.

According to an aspect of the present invention, the temperature data converting portion may classify temperature into different ranges in accordance with where in the image forming apparatus the temperature sensors are disposed.

According to an aspect of the present invention, the paper feeding time calculating portion may calculate the average of the paper feeding time data to determine the paper feeding time.

According to another aspect of the present invention, there is provided a method of controlling the temperature of an image forming apparatus by adjusting a paper feeding time, the method including: sensing the temperatures of respective parts of the image forming apparatus; converting the sensed temperatures into a paper feeding time according to a fuzzy rule for converting temperatures into paper feeding times; and feeding printing paper in accordance with the converted paper feeding time.

According to an aspect of the present invention, the sensing of the temperatures may include sensing the temperatures of parts of the image forming apparatus that dissipate heat and/or the parts that are sensitive to heat.

According to an aspect of the present invention, the converting of the sensed temperatures may include applying different fuzzy rules in accordance with which part of the image forming apparatus is sensed.

According to an aspect of the present invention, the converting of the sensed temperatures may include: converting the sensed temperatures into fuzzy data; and converting the converted fuzzy data into a paper feeding time.

According to an aspect of the present invention, the converting of the sensed temperatures into fuzzy data may include: converting the sensed temperatures into temperature data that represents correlations with the ranges of temperatures that are classified into predetermined ranges; and converting the converted temperature data into paper feeding time data that represents the ranges of paper feeding times that are classified into predetermined ranges.

According to an aspect of the present invention, the converting of the converted temperature data into paper feeding time data may include: inferring the ranges of the paper feeding times corresponding to the ranges of the temperatures having correlations with the sensed temperatures according to the fuzzy rule; and adjusting correlations of the inferred ranges of the paper feeding times using the temperature data.

According to an aspect of the present invention, the converting of the sensed temperatures into temperature data may include classifying temperature into different ranges in accordance with where in the image forming apparatus the temperatures are sensed.

According to an aspect of the present invention, the converting of the converted fuzzy data into the paper feeding times may include calculating the average of the paper feeding time data to determine the paper feeding time.

According to an aspect of the present invention, there is provided a computer readable medium that stores a computer readable program that executes a method of controlling the temperature of the image forming apparatus.

According to an aspect of the present invention, there is provided an image forming apparatus that includes an apparatus for controlling the temperature of an image forming apparatus by adjusting the paper feeding time or print speed of the image forming apparatus as described herein.

According to an aspect of the present invention, there is provided an apparatus that controls a temperature of an image forming apparatus by adjusting a print speed of the image forming apparatus, the apparatus comprising: a temperature sensing unit including at least one temperature sensor to sense an internal temperatures of the image forming apparatus; a print speed adjusting unit that adjusts a print speed of the image forming apparatus according to a logical relationship between the sensed temperature and print speed of the image forming apparatus to maintain the temperature of the image forming apparatus at or below a maximum temperature.

According to an aspect of the present invention, there is provided method of controlling temperature of an image forming apparatus by adjusting a print speed, the method comprising: sensing a temperature of at least one location of the image forming apparatus; and adjusting the print speed according to a logical relationship between the sensed temperature and print speed of the image forming apparatus to maintain the temperature of the image forming apparatus at or below a maximum temperature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a structure of an apparatus for controlling temperature of an image forming apparatus according to an embodiment of the present invention;

FIG. 2A is a graph showing temperature of a first temperature sensor 110 versus temperature data;

FIG. 2B is a graph showing temperature of an N-th temperature sensor 119 versus temperature data;

FIG. 3A is a graph showing a paper feeding time versus paper feeding time data;

FIG. 3B is a graph showing a paper feeding time versus paper feeding time data;

FIG. 3C is a graph showing a paper feeding time versus paper feeding time data; and

FIG. 4 is a flowchart illustrating a method of controlling temperature of an image forming apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

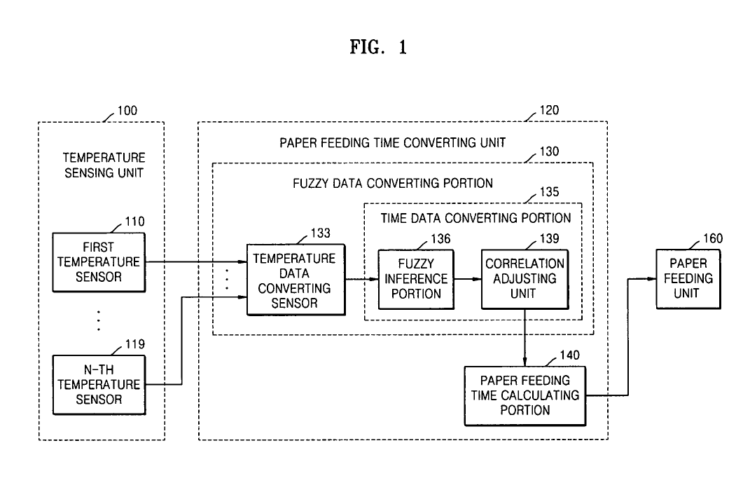

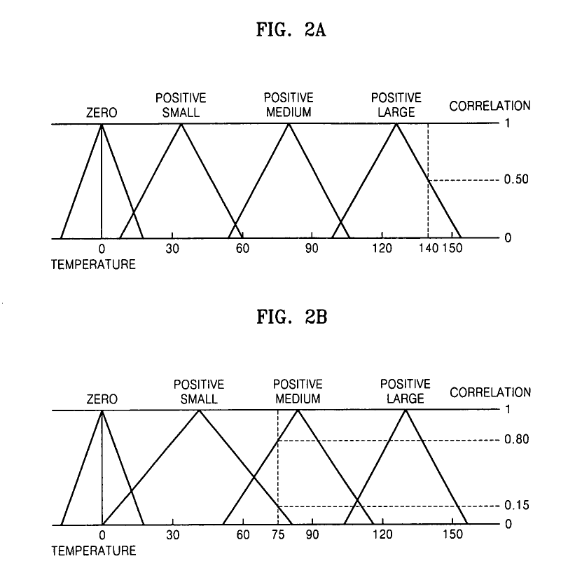

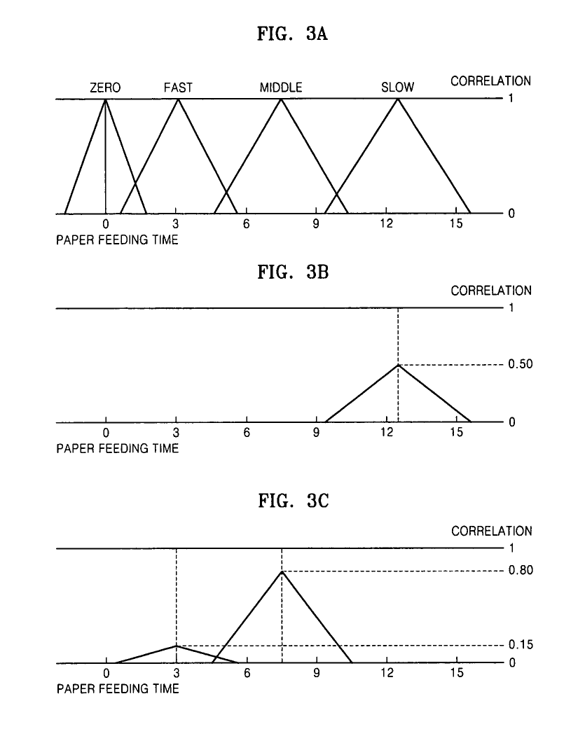

FIG. 1 is a block diagram showing a structure of an apparatus for controlling the temperature of an image forming apparatus according to an embodiment of the present invention. Conventional details of an image forming apparatus are not shown. Moreover, although the description herein refers to a “paper feeding unit” and “paper feeding time,” it is to be understood that the medium onto which an image is formed by the image forming apparatus is not limited to printing paper, but can be any printing medium that is serially fed to an image forming apparatus. Therefore, as used herein, the terms “paper” and “printing paper” refer to any printing medium used in an image forming apparatus, regardless of its composition. The apparatus of FIG. 1 includes a temperature sensing unit 100, a paper feeding time converting unit 120, and a paper feeding unit 160. The structure of the apparatus will now be described with reference to FIGS. 2A, 2B, 3A, 3B, and 3C.

The temperature sensing unit 100 includes first through N-th temperature sensors 110-119 (where, N is an integer greater than 2) to sense temperatures of various parts of an image forming apparatus, particularly the inside of the image forming apparatus. The designation of the temperature sensors as 110-119 is for convenience and is not meant to indicate that the number of temperature sensors is limited to ten.

The first through N-th temperature sensors 110 to 119 may be disposed in parts of the image forming apparatus that dissipate heat, such as a heater roller, and/or in parts of the image forming apparatus that are sensitive to heat, such as a photosensitive drum according to an aspect of the invention. What is meant by “sensitive to heat” is that a part is damaged or the quality of its performance is affected when it is exposed to excessive heat. However, it is to be understood that the sensors 110 to 119 can be otherwise disposed in the apparatus.

The paper feeding time converting unit 120 calculates a feeding time of paper through the image forming apparatus based on temperatures sensed in the first through N-th temperature sensors 110-119 and according to a fuzzy rule base.

The paper feeding time converting unit 120 includes a fuzzy data converting portion 130 and a paper feeding time calculating portion 140.

The fuzzy data converting portion 130 converts the temperatures sensed in the first through N-th temperature sensors 110-119 into fuzzy data.

The fuzzy data converting portion 130 includes a temperature data converting portion 133 and a time data converting portion 135.

The temperature data converting portion 133 converts the temperatures sensed in the first through N-th temperature sensors 110-119 into temperature data. The term “temperature data” refers to data in which temperatures are classified into predetermined ranges and the classified ranges about each temperature and the correlation therebetween are indicated. In the temperature data, the predetermined range can be repeatedly classified.

FIG. 2B is a graph showing the temperature of an N-th temperature sensor 119 versus temperature data. Referring to FIG. 2B, temperatures are classified into predetermined ranges as: −20-20 degrees as “zero”, 0-80 degrees as “positive small”, 45-110 degrees as “positive medium”, and 105-155 degrees as “positive large”, respectively, and the temperature data show a correlation between “zero”, “positive small”, “positive medium”, and “positive large”, which is the range classified about each temperature. Referring to FIG. 2B, for example, if the temperature sensed in the N-th temperature sensor 119 is 75 degrees, the temperature is included in the range of “positive small” and “positive medium”. It is to be understood that the ranges can be otherwise defined and/or that additional or fewer fuzzy sets can be defined.

As can be seen by comparing FIG. 2A, showing temperature data of the first temperature sensor 110, and FIG. 2B, showing temperature data of the N-th temperature sensor 119, the temperature data converting portion 133 classifies temperatures into different ranges according to the parts where the first through N-th temperature sensors 110-119 are disposed. In other words, what is meant by “zero”, “positive small”, “positive medium” and “positive large” can be different for different sensors, and for each sensor, the predetermined ranges are selected according to where the sensor will be placed in the image forming apparatus. For example, if a particular temperature sensor is disposed in a part of an image forming apparatus that is sensitive to high temperatures, the predetermined ranges for that sensor will be selected so that temperatures are classified as “positive large” at a lower temperature, in comparison to sensors that disposed at less sensitive sites in the image forming apparatus.

Referring to FIG. 2A, if the temperature sensed in the first temperature sensor 110 is 140 degrees, the sensed temperature is converted into temperature data showing a correlation between “positive large” and 0.50. Referring to FIG. 2B, if the temperature sensed in the N-th temperature sensor 119 is 75 degrees, the sensed temperature is converted into temperature data showing a correlation between “positive small” and 0.15 and a correlation between “positive medium” and 0.80.

The time data converting portion 135 converts the temperatures converted by the temperature data converting portion 133 into paper feeding time data. The term “paper feeding time” refers to the amount of time it takes for a single piece of paper or other print medium to go from being input into an image forming operation to being output with an image formed thereon at the conclusion of the image forming operation. Moreover, it is to be understood that the term “paper feeding time” may refer to a feeding time in selected locations within the apparatus. The term “paper feeding time data” refers to data in which temperatures are classified into predetermined ranges and the classified ranges about each paper feeding time and the correlation therebetween are indicated. In the paper feeding time data, the predetermined range can be repeatedly classified.

FIG. 3A is a graph showing a paper feeding time versus paper feeding time data. Referring to FIG. 3A, the paper feeding time is classified as: 0-1 second as “zero”, 0.5-5.5 second as “fast”, 4.5-10.5 second as “middle”, and 9.5-15.5 second as “slow”, respectively, and the paper feeding time data shows correlation between “zero”, “fast”, “middle”, and “slow” which is the range classified about each paper feeding time.

The time data converting portion 135 includes a fuzzy inference portion 136 and a correlation adjusting portion 139.

According to the fuzzy rule base, the fuzzy inference portion 136 performs fuzzy inference on the range of the paper feeding times to correspond to the range having correlation with the temperatures sensed in the first through N-th temperature sensors 110-119. According to the fuzzy rule set based on the following Table 1, the range of the paper feeding times corresponding to the range of temperatures is inferred.

TABLE 1

| | | | | |
|---|---|---|---|---|
| Temperature | Zero | Positive | Positive | Positive |
| | | small | medium | large |
| Paper feeding | Zero | Fast | Middle | Slow |
| time | | | | |

For example, if 140° C. is sensed by the first temperature sensor 110, as shown in FIG. 2A, the temperature is converted into temperature data that represents a correlation between “positive large” and 0.50, and, according to Table 1, the range of the temperature, “positive large” is inferred as “slow”, which is the range of the paper feeding time. Also, if 75° C. is sensed by the N-th temperature sensor 119, as shown in FIG. 2B, the temperature is converted into temperature data that represents correlations between “positive small” and 0.15 and between “positive medium” and 0.80, and according to Table 1, the range of the temperature, “positive small” is inferred as the range of the paper feeding time, “fast”, and the range of the temperature, “positive medium” is inferred as the range of the paper feeding time, “middle”.

The correlation adjusting portion 139 adjusts correlations between the ranges of the paper feeding times that are inferred by the fuzzy inference portion 136, using the temperature data converted by the temperature data converting portion 133. For example, if 140° C. is sensed by the first temperature sensor 110, the height of “slow” shown in FIG. 3A is reduced by the ratio of 0.50 in accordance with the correlation of the temperature data to convert the temperature into the paper feeding data, as shown in FIG. 3B. Also, if 75° C. is sensed by the N-th temperature sensor 119, the height of “fast” shown in FIG. 3A is reduced by the ratio of 0.15 and the height of “middle” is reduced by the ratio of 0.80 in accordance with the correlations of the temperature data to convert the temperature into the paper feeding data, as shown in FIG. 3C.

The paper feeding time calculating portion 140 calculates the average of all of the paper feeding time data adjusted by the correlation adjusting unit 139 to determine a paper feeding time. The paper feeding time calculating unit 140 adds all of the paper feeding time data obtained by converting the temperatures sensed by the first to N-th temperature sensors 110-119, as shown in FIGS. 3B and 3C, to calculate the average of the curves and determine the paper feeding time. When the average of the curves is calculated, the paper feeding time of the coordinates corresponding to the center of gravity of the graph that is obtained by adding all of the paper feeding time data is determined as the paper feeding time.

The paper feeding unit 160 supplies a printing paper in accordance with the paper feeding time determined by the paper feeding time calculating portion 140.

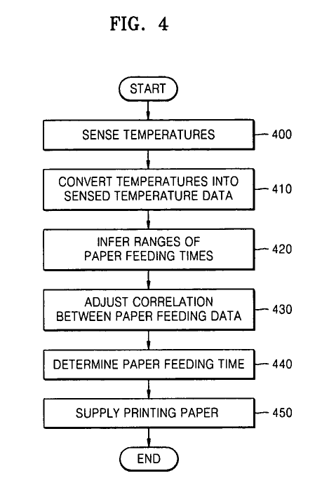

FIG. 4 is a flowchart illustrating a method of controlling temperature of an image forming apparatus according to an embodiment of the present invention.

First, temperatures of respective parts of the image forming apparatus are sensed in operation 400. In operation 400, the temperatures are sensed by at least two or more temperature sensors so that the temperature of the entire inside of the image forming apparatus is sensed. Also, in operation 400, the temperatures of parts that dissipate heat, such as a heater roller, or the temperatures of parts that are sensitive to heat, such as a photosensitive drum, may be sensed.

In operation 410, temperatures sensed in the operation 400 are converted into temperature data that represents correlations between the sensed temperatures and predetermined, classified ranges of temperatures.

After operation 410, ranges of paper feeding times corresponding to the ranges of the temperatures having correlations between the temperatures sensed in the operation 400 are inferred according to the fuzzy rule base in operation 420.

In operation 430, correlations between the ranges of paper feeding times that are inferred in operation 420 are adjusted in accordance with the temperature data converted in operation 410.

In operation 440, the average of the paper feeding time data for which correlations are adjusted in operation 430 is calculated to determine the paper feeding time. In operation 440, all of the paper feeding time data obtained by converting the temperatures sensed by all of the temperature sensors is added together to calculate an average. When the average of the curves is calculated, the paper feeding time of the coordinates corresponding to the center of gravity of the graph that is obtained by adding all of the paper feeding time data is determined as the printing paper feeding time.

In operation 450, a printing paper is supplied in accordance with the paper feeding time determined in operation 440.

An overall result achieved by the apparatus and method described herein is that the temperature of the image forming apparatus is controlled. For example, if the temperature of the image forming apparatus is sensed as being high, the result of the operations described herein will be to carry out printing according to a determined slow paper feeding time, which will have the result of allowing the apparatus to cool. On the other hand, if the temperature of the image forming apparatus is sensed as being low, the result of the operations described herein will be to carry out printing according to a determined fast paper feeding time, which will have the result of causing the apparatus to become hotter. Moreover, the method may be repeated or carried out continuously during an operation of an image forming apparatus to provide a paper feeding time and control the temperature of the image forming apparatus. For example, the image forming apparatus may be operating at an initial paper feeding time or at a previously calculated feeding time, and the method is carried out to determine whether the image forming apparatus should be operating with a new calculated paper feeding time in order to control the temperature of the image forming apparatus.

Further, while aspects of the invention are described in terms of fuzzy logic and multiple sensors, it is to be understood that other aspects can use other logic forms and/or use only one physical sensor to model temperatures in other locations of the image forming apparatus.

Although the apparatus and method described herein are described in terms of adjusting the paper feeding time, it is to be understood that other parameters that can be calculated from the paper feeding time, such as paper speed or pages per minute (ppm), may be used in the apparatus and method instead of paper feeding time. For example, the paper feeding time converting unit 120 may calculate a paper speed or ppm rate of the image forming apparatus based on the sensed temperatures, predetermined temperature data and predetermined paper speed or ppm data.

The invention can also be embodied as computer (including all devices having an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus that controls a temperature of an image forming apparatus by adjusting a paper feeding time, the apparatus comprising:
a temperature sensing unit including a plurality of temperature sensors to sense temperatures of respective parts of the image forming apparatus;
a paper feeding time converting unit that converts the sensed temperatures into a paper feeding time according to a fuzzy rule; and
a paper feeding unit that feeds printing paper in accordance with the converted paper feeding time.

2. The apparatus of claim 1, wherein some of the temperature sensors of the temperature sensing unit are disposed to sense temperatures in parts of the image forming apparatus that dissipate heat and/or parts of the image forming apparatus that are sensitive to heat.

3. The apparatus of claim 1, wherein the paper feeding time converting unit applies different fuzzy rules with respect to sensed temperatures of different temperature sensors in accordance with where the temperature sensors are disposed.

4. The apparatus of claim 3, wherein the paper feeding time converting unit comprises:
a fuzzy data converting portion that converts the sensed temperatures into fuzzy data; and
a paper feeding time calculating portion that converts the converted fuzzy data into the paper feeding time.

5. The apparatus of claim 4, wherein the fuzzy data converting portion comprises:
a temperature data converting portion that converts the sensed temperatures into temperature data that represents correlations with predetermined ranges of temperatures; and
a time data converting portion that converts the converted temperature data into paper feeding time data that represents predetermined ranges of paper feeding times.

6. The apparatus of claim 5, wherein the time data converting portion comprises:
a fuzzy inference portion that infers the ranges of paper feeding times corresponding to the ranges of temperatures having correlations with the sensed temperatures according to the fuzzy rule; and
a correlation adjusting portion that adjusts correlations of the inferred ranges of the paper feeding times using the temperature data.

7. The apparatus of claim 5, wherein the temperature data converting portion classifies the sensed temperature into different ranges in accordance with where the temperature sensors are disposed.

8. The apparatus of claim 5, wherein the paper feeding time calculating portion calculates the average of the paper feeding time data to determine the paper feeding time.

9. A method of controlling temperature of an image forming apparatus by adjusting a paper feeding time, the method comprising:
sensing the temperatures of respective parts of the image forming apparatus;
converting the sensed temperatures into a paper feeding time according to a fuzzy rule for converting temperatures into paper feeding times; and
feeding printing paper in accordance with the converted paper feeding time.

10. The method of claim 9, wherein the sensing of the temperatures comprises sensing the temperatures of parts of the image forming apparatus that dissipate heat and/or parts that are sensitive to heat.

11. The method of claim 9, wherein the converting of the sensed temperatures comprises applying different fuzzy rules in accordance with which part of the image forming apparatus is sensed.

12. The method of claim 11, wherein the converting of the sensed temperatures comprises:
converting the sensed temperatures into fuzzy data; and
converting the converted fuzzy data into a paper feeding time.

13. The method of claim 12, wherein the converting of the sensed temperatures into fuzzy data comprises:
converting the sensed temperatures into temperature data that represents correlations with ranges of temperatures that are classified into predetermined ranges; and
converting the converted temperature data into paper feeding time data that represents ranges of paper feeding times that are classified into predetermined ranges.

14. The method of claim 13, wherein the converting of the converted temperature data into paper feeding time data comprises:
inferring the ranges of the paper feeding times corresponding to the ranges of the temperatures having correlations with the sensed temperatures according to the fuzzy rule; and
adjusting correlations of the inferred ranges of the paper feeding times using the temperature data.

15. The method of claim 13, wherein the converting of the sensed temperatures into temperature data comprises classifying temperatures into different ranges in accordance with where in the image forming apparatus the temperatures are sensed.

16. The method of claim 13, wherein the converting of the converted fuzzy data into the paper feeding time comprises calculating the average of the paper feeding time data to determine the paper feeding time.

17. The method of claim 9, wherein the method is repeated during an operation of an image forming apparatus.

18. A computer readable medium storing a computer readable program that executes the method of claim 9.

19. An image forming apparatus in which a temperature of the image forming apparatus by adjusting a paper feeding time, the image forming apparatus comprising:
a temperature sensing unit to sense temperatures of respective parts of the image forming apparatus;
a paper feeding time converting unit that converts the sensed temperatures into a paper feeding time according to a fuzzy rule; and
a paper feeding unit that feeds printing paper in accordance with the converted paper feeding time.

20. An apparatus that controls a temperature of an image forming apparatus by adjusting a print speed of the image forming apparatus, the apparatus comprising:
a temperature sensing unit including at least one temperature sensor to sense an internal temperature of the image forming apparatus; and
a print speed adjusting unit that adjusts a print speed of the image forming apparatus according to a logical relationship between the sensed temperature and print speed of the image forming apparatus to maintain the temperature of the image forming apparatus at or below a maximum temperature.

21. The apparatus of claim 20, wherein the temperature sensing unit comprises a plurality of temperature sensors and wherein the logical relationship between the sensed temperature and the print speed of the image forming apparatus is determined by fuzzy logic.

22. A method of controlling temperature of an image forming apparatus by adjusting a print speed, the method comprising:
sensing a temperature of at least one location of the image forming apparatus; and
adjusting the print speed according to a logical relationship between the sensed temperature and print speed of the image forming apparatus to maintain the temperature of the image forming apparatus at or below a maximum temperature.

23. The apparatus of claim 22, wherein the temperature sensing unit comprises a plurality of temperature sensors and wherein the logical relationship between the sensed temperature and the print speed of the image forming apparatus is determined by fuzzy logic.
